(19) United States
(12) Patent Application Publication
(10) Pub. No.: US 2019/0130007 A1
(43) Pub. Date: May 2, 2019

(54) FACILITATING AUTOMATIC EXTRACT, TRANSFORM, LOAD (ETL) PROCESSING

(71) Applicant: International Business Machines Corporation, Armonk, NY (US)

(72) Inventors: Bibo Hao, Beijing (CN); Jian Min Jiang, Beijing (CN); Ying Xue Li, Beijing (CN); Wen Sun, Beijing (CN); Guo Tong Xie, Xi Er Qi (CN); Yi Qin Yu, Beijing (CN)

(21) Appl. No.: 15/798,600

(22) Filed: Oct. 31, 2017

(51) Int. Cl. G06F 17/30; G06F 17/18

(52) U.S. Cl. CPC G06F 17/30563; G06F 17/18

(57) ABSTRACT

Techniques are provided that facilitate determining, by a system operatively coupled to a processor, respective performance scores for a first set of candidate transformation scripts based on a performance criterion, wherein the candidate transformation scripts are related to extract, transform, load (ETL) processing of a new data source to a data target. Techniques are also provided that facilitate generating, by the system, a recommendation of one or more of the first set of candidate transformation scripts based on the respective performance scores for performance of the ETL processing.

### BACKGROUND

The subject disclosure relates generally to automatically performing ETL processing of one or more data sources to a data target.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. One or more embodiments described herein include a system, computer-implemented method, and/or computer program product that facilitate automatically performing ETL processing of one or more data sources to a data target.

According to an embodiment, a system is provided. The system comprises a memory that stores computer executable components; and a processor that executes the computer executable components stored in the memory. The computer executable components can comprise: a transformation script evaluation component that determines respective performance scores for a first set of candidate transformation scripts based on a performance criterion, wherein the candidate transformation scripts are related to extract, transform, load (ETL) processing of a new data source to a data target; and a recommendation component that generates a recommendation of one or more of the first set of candidate transformation scripts based on the respective performance scores for performance of the ETL processing.

The performance criterion can also be based on utilization of at least one resource selected from the group consisting of a processor, a memory, a storage device, and a network bandwidth. This provides a benefit by reducing resource utilization of a computing device that performs ETL processing of a new data source to a data target.

In another embodiment, a computer-implemented method is provided. The computer-implemented method can include determining, by a system operatively coupled to a processor, respective performance scores for a first set of candidate transformation scripts based on a performance criterion, wherein the candidate transformation scripts are related to extract, transform, load (ETL) processing of a new data source to a data target; and generating, by the system, a recommendation of one or more of the candidate transformation scripts based on the respective performance scores for performance of the ETL processing.

The performance criterion can be based on a determined accuracy of execution of a candidate transformation script on a sample historical dataset. This provides a benefit by improving accuracy of a computing device that performs ETL processing of a new data source to a data target.

In another embodiment, a computer program product for extract, transform, load (ETL) processing of a new data source to a data target is provided. The computer program product can include a computer readable storage medium having program instructions embodied therewith. The program instructions can be executable by a processor to cause the processor to: determine respective performance scores for a first set of candidate transformation scripts based on a performance criterion, wherein the candidate transformation scripts are related to extract, transform, load (ETL) processing of a new data source to a data target; and generate a recommendation of one or more of the first set of candidate transformation scripts based on the respective performance scores for performance of the ETL processing.

### BRIEF DESCRIPTION OF THE DRAWINGS

FIG. 1 illustrates a block diagram of an example, non-limiting system in accordance with one or more embodiments described herein.

FIG. 2 illustrates a block diagram of an example, non-limiting ETL component in accordance with one or more embodiments described herein.

FIG. 3 illustrates a block diagram of an example, non-limiting ETL framework component in accordance with one or more embodiments described herein.

FIG. 4 illustrates a block diagram of an example, non-limiting ETL transformation script generation operation in accordance with one or more embodiments described herein.

FIG. 5 illustrates a block diagram of example, non-limiting query plan trees in accordance with one or more embodiments described herein.

FIG. 6 illustrates a flow diagram of another exemplary, non-limiting computer-implemented method in accordance with one or more embodiments described herein.

FIG. 7 illustrates a flow diagram of another exemplary, non-limiting computer-implemented method in accordance with one or more embodiments described herein.

FIG. 8 illustrates a flow diagram of another exemplary, non-limiting computer-implemented method in accordance with one or more embodiments described herein.

FIG. 9 illustrates a flow diagram of another exemplary, non-limiting computer-implemented method in accordance with one or more embodiments described herein.

FIG. 10 illustrates a block diagram of an example, non-limiting operating environment in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however in various cases, that the one or more embodiments can be practiced without these specific details.

With the advent of systems that perform analysis (e.g., mining, learning, modeling, predicting, or any other suitable form of data analysis) of large datasets, there is a desire to transform a vast amount of heterogenous data sources into a homogenous data target. For example, in performing clinical studies, an electronic health record (EHR) for a large dataset of patients can come from a plurality of hospital systems, each employing different systems and data schemas. Furthermore, while many of the EHR fields may relate to similar data, they can have different names and different formats. Transformation scripts (e.g., query plan trees) can be inaccurate and inefficient in terms of resource utilizations (e.g., memory utilization, storage utilization, processing utilization, bandwidth utilization). It is to be appreciated that while embodiments describe herein employ clinical studies for exemplary purposes only, any suitable type of data can processed using ETL techniques described herein.

To address the challenges in performing ETL processing as described herein, one or more embodiments described herein can employ techniques that utilize historical data and transformation scripts to automatically perform ETL processing of new data sources. For example, a new data source can be processed for alignment of column names, data cleansing, and data normalization to a data target. A source schema of a new data source can be mapped to a target schema of the data target and to historical schemas. The mappings can be employed to identify candidate transformation scripts from portions of historical transformation scripts for employment in ETL processing of the new data source. The candidate transformation scripts can be ranked according to a ranking criterion. A top ranked subset of the candidate transformation scripts can be scored based on performance on a sample historical dataset and a scoring criterion. For example, performance can be evaluated based on accuracy and/or resource utilization. A subset of highest scoring candidate transformation scripts can be recommended to an entity (e.g., machine, hardware, software and/or human) for selection in ETL processing of the new data source to the data target. In another example, the embodiments can automatically employ one or more of the subset of highest scoring candidate transformation scripts for selection in ETL processing of the new data source to the data target.

One or more embodiments of the subject disclosure is directed to computer processing systems, computer-implemented methods, apparatus and/or computer program products that facilitate efficiently, effectively, and automatically (e.g., without direct human involvement) perform ETL processing of new data sources. The computer processing systems, computer-implemented methods, apparatus and/or computer program products can employ hardware and/or software to solve problems that are highly technical in nature (e.g., adapted to generate and/or employ one or more different detailed, specific and highly-complex transformation scripts that can automatically perform ETL processing of new data sources) that are not abstract and that cannot be performed as a set of mental acts by a human. For example, a human, or even thousands of humans, cannot efficiently, accurately and effectively manually gather and analyze thousands of data records related to a variety of observations in a real-time network based computing environment to perform ETL processing of new data sources. One or more embodiments of the subject computer processing systems, methods, apparatuses and/or computer program products can enable the automated perform ETL processing of new data sources in a highly accurate and efficient manner. By employing a scored transformation scripts, the processing time and/or accuracy associated with the automated performance of ETL processing of new data sources is substantially improved. Additionally, the nature of the problem solved is inherently related to technological advancements in performance of ETL processing of new data sources that have not been previously addressed in this manner. Further, one or more embodiments of the subject ETL processing techniques can facilitate improved performance of automated performance of ETL processing of new data sources that provides for more efficient usage of storage resources, processing resources, and network bandwidth resources to provide highly granular and accurate ETL processing of new data sources. For example, by scoring transformation scripts based on their accuracy, memory utilization, storage utilization, processing utilization, and/or bandwidth utilization for ETL processing, efficiency and effectiveness is improved, and wasted usage of processing, memory, storage, and network bandwidth resources can be avoided by decreasing the amount of data being stored and processed while also provided a more accurate result (e.g., migration of new data source to data target). This provides a clear technical improvement to the operation of the highly-specialized computing device on which ETL processing is executed.

By way of overview, aspects of systems, apparatuses, or processes in accordance with the present invention can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

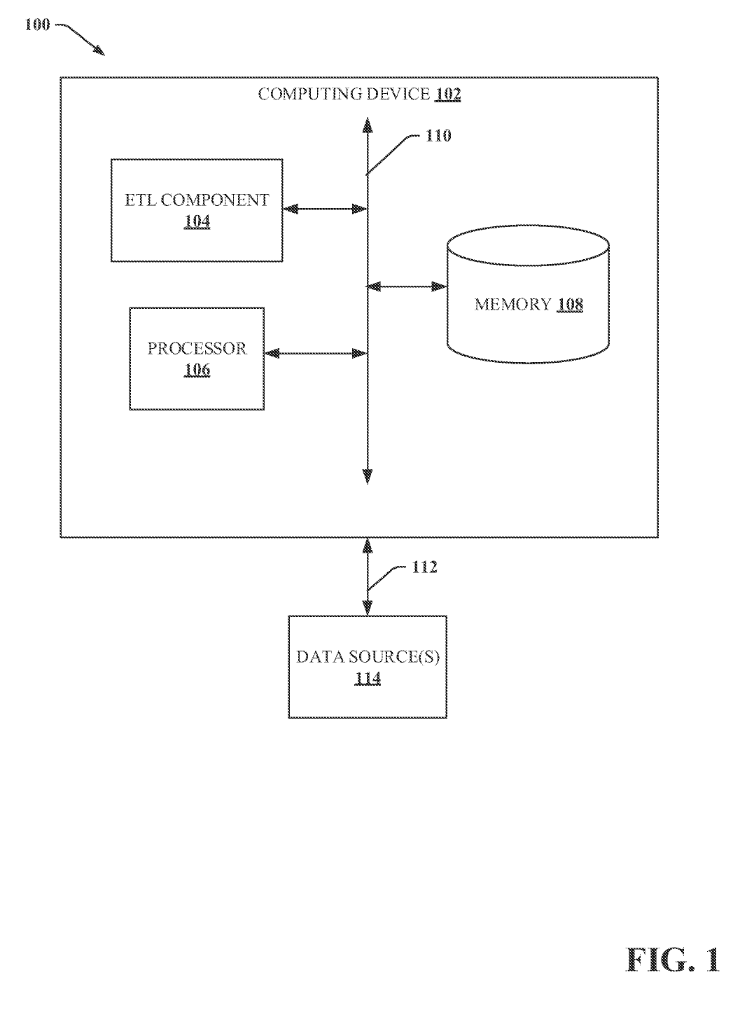

FIG. 1 illustrates a block diagram of an example, non-limiting system 100 that facilitates automatically performing ETL processing of one or more data sources to a data target in accordance with one or more embodiments described herein. Repetitive description of like elements employed in one or more embodiments described herein is omitted for sake of brevity.

System 100 can include a computing device 102, one or more networks 112, and one or more data sources 114. Computing device 102 can include an ETL component 104 that can facilitate automatically performing ETL processing of one or more data sources to a data target as discussed in more detail below.

Computing device 102 can also include or otherwise be associated with at least one included (or operatively coupled to) memory 108 that can store computer executable components (e.g., computer executable components can include, but are not limited to, the ETL component 104 and associated components), and can store any data generated by ETL component 104 and associated components. Computing device 102 can also include or otherwise be associated with at least one processor 106 that executes the computer executable components stored in memory 108. Computing device 102 can further include a system bus 110 that can couple the various server components including, but not limited to, the ETL component 104, memory 108 and/or processor 106.

Computing device 102 can be any computing device that can be communicatively coupled to one or more data sources 114, non-limiting examples of which can include, but are not limited to, a wearable device or a non-wearable device. A wearable device can include, for example, heads-up display glasses, a monocle, eyeglasses, contact lens, sunglasses, a headset, a visor, a cap, a mask, a headband, clothing, or any other suitable device that can be worn by a human or non-human user. Non-wearable devices can include, for example, a mobile device, a mobile phone, a camera, a camcorder, a video camera, laptop computer, tablet device, desktop computer, server system, cable set top box, satellite set top box, cable modem, television set, monitor, media extender device, blu-ray device, digital versatile disc or digital video disc (DVD) device, compact disc device, video game system, portable video game console, audio/video receiver, radio device, portable music player, navigation system, car stereo, a mainframe computer, a robotic device, a wearable computer, an artificial intelligence system, a network storage device, a communication device, a web server device, a network switching device, a network routing device, a gateway device, a network hub device, a network bridge device, a control system, or any other suitable computing device 102.

A data source 114 can be any device that can communicate with computing device 102 and that can provide information to computing device 102 or receive information provided by computing device 102. For example, data source 114 can be a hospital server that maintains patient EHRs. Computing device 102 can obtain one or more datasets of patient EHRs from data source 114. It is to be appreciated that computing device 102 and data source 114 can be equipped with communication components (not shown) that enable communication between computing device 102, and data source 114 over one or more networks 112.

The various devices (e.g., computing device 102, and data source 114) and components (e.g., ETL component 104, memory 108, processor 106 and/or other components) of system 100 can be connected either directly or via one or more networks 112. Such networks 112 can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

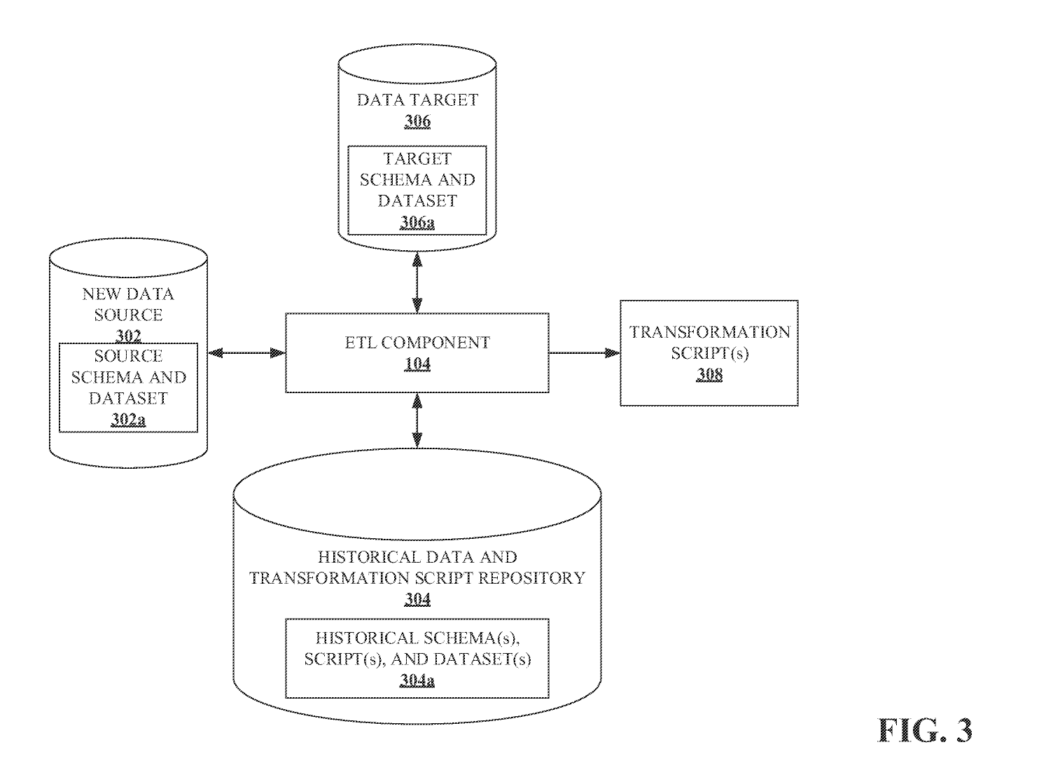

FIG. 3 illustrates a block diagram of an example, non-limiting ETL component 104 framework in accordance with one or more embodiments described herein. Repetitive description of like elements employed in one or more embodiments described herein is omitted for sake of brevity.

ETL component 104 can obtain data from a data source 302 comprising a source schema and dataset 302a, from a data target 306 comprising a target schema and dataset 306a, and from a historical data and transformation script repository 304 comprising one or more historical schemas, transformation scripts, and datasets 304a, and can generate one or more transformation scripts 308 for performing ETL processing of data from data source 302 to data target 306 as described in more detail below. It is to be appreciated that a historical data and transformation script repository can comprise historical data sources for which ETL processing occurred to data target 306 using historical schemas, historical datasets, and historical transformation scripts. The historical transformation scripts can previously have been automatically generated by ETL component 104 or manually generated in various different embodiments.

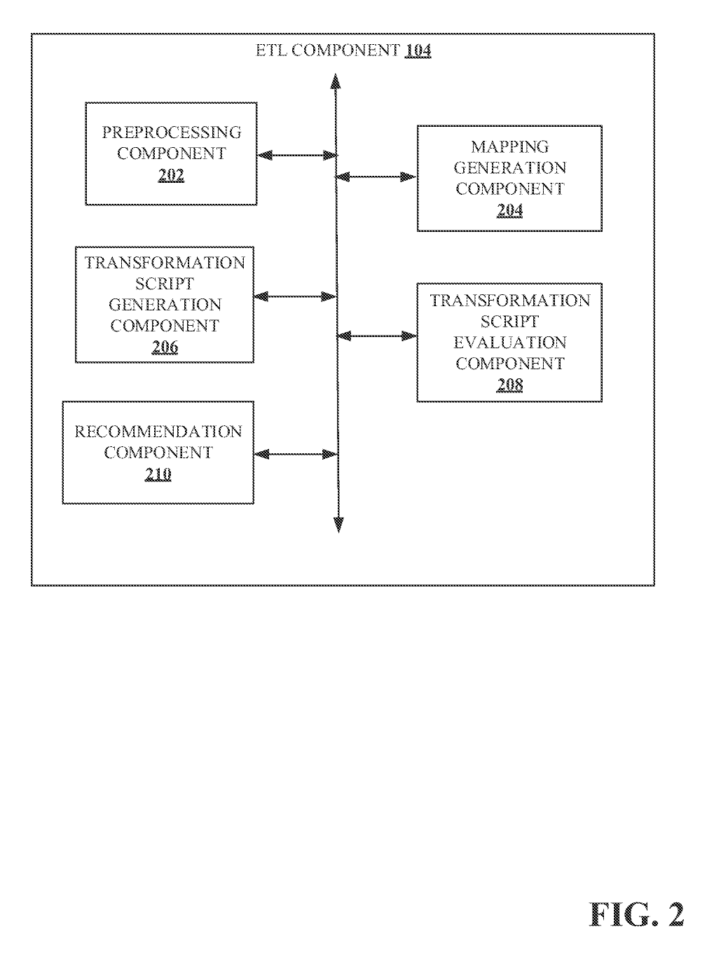

FIG. 2 illustrates a block diagram of an example, non-limiting ETL component 104 in accordance with one or more embodiments described herein. Repetitive description of like elements employed in one or more embodiments described herein is omitted for sake of brevity.

ETL component 104 can include preprocessing component 202 that can automatically preprocess a new data source. ETL component 104 can also include mapping component 204 that can automatically generate mappings from a source schema of a new data source to a target schema of the data target and to historical schemas. Furthermore, ETL component 104 can also include transformation script generation component 206 that can automatically identify candidate transformation scripts from portions of historical transformation scripts for employment in ETL processing of the new data source. Additionally, ETL component 104 can also include transformation script evaluation component 208 that can automatically evaluate performance of candidate transformation scripts based on accuracy and/or resource utilization. ETL component 104 can also include recommendation component 210 that can recommend one or more candidate transformation scripts to an entity (e.g., machine, hardware, software, human) for selection in ETL processing of the new data source to the data target.

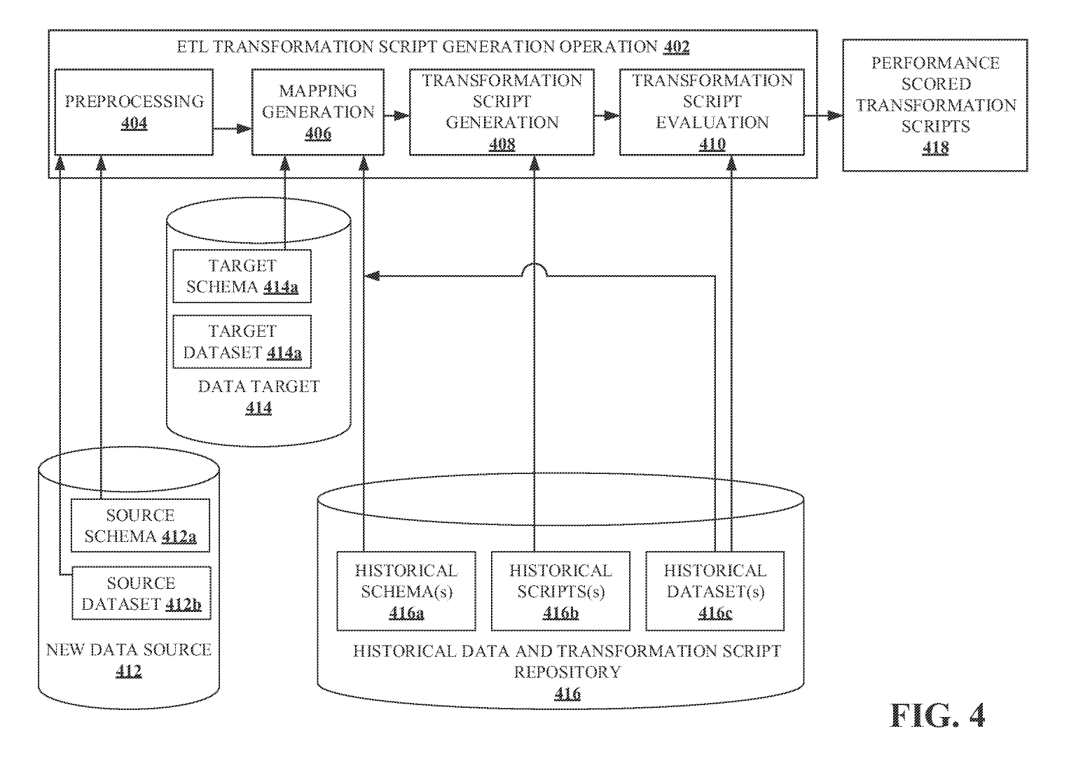

FIG. 4 illustrates a block diagram of an example, non-limiting ETL transformation script generation operation 402 of a modified random forest model by ETL component 104 in accordance with one or more embodiments described herein. Repetitive description of like elements employed in one or more embodiments described herein is omitted for sake of brevity.

As indicated at element 404, preprocessing component 202 can perform preprocessing 404 on a new data source 412 that comprises source schema 412a having source dataset 412b. In a non-limiting example, preprocessing component 202 can perform preprocessing 404 on one or more views of new data source 412 to avoid directly changing new data source. In another non-limiting example, preprocessing component 202 can perform preprocessing 404 directly on new data source 412. Preprocessing component 202 can annotate one or more tables (e.g. key tables or any other suitable tables) of source schema 412a with metadata. For example, one or more table names and/or column names can be tagged with metadata that employs names that are in alignment with names used in the target schema 414a of data target 414, a naming standard, user specified names, or any other suitable naming convention. For example, in an EHR, metadata for column names can include patient_id, row_key, timestamp, or any other suitable column names. Using metadata annotation can advantageously allow for easier mapping by mapping component 204 as table and/or column names can be consistent across schemas. Preprocessing component 202 can also join many-to-one relations, including codes and dictionaries, in source schema 412a in order to produce flattened tables. This can advantageously reduce the complexity of mapping and transformation.

Preprocessing component 202 can clean data in source dataset 412b according to data type (e.g., integer, character, Boolean, decimal, or any other suitable data type). If a particular data type is expected in a column, preprocessing component 202 can verify that data values in source dataset 412b for the column meet the particular data type. For example, if a column is expected to have a Boolean data type and a data record in source dataset 412b has a decimal value for the column, then preprocessing component 202 can identify this mismatch of data type. Furthermore, preprocessing component 202 can take an action to resolve the mismatch. In an example, preprocessing component 202 can modify the value to null for the data record. In another example, preprocessing component 202 can employ artificial intelligence techniques to predict a data value for the data record for the column. For example, preprocessing component 202 can employ data values from other columns for the data record to predict the data value for the column where the mismatch has occurred.

Preprocessing component 202 can also normalize data values in source dataset 412b based on the data target, a data standard, or any other suitable normalization convention. In a non-limiting example, normalization can include scaling, shifting, rewriting, or any other suitable normalization technique. For example, a lab test result may use different scales in different systems. Preprocessing component 202 can scale data values in source dataset 412b to correspond to data scales used in target schema 414a of data target 414. In another example, a single medication can have a variety of brand names and a generic name. Preprocessing component 202, for example, can normalize the name used for the medication in source dataset 412b to the generic name. Similarly, a medical procedure can have a variety of names and acronyms used to describe the medical procedure. Preprocessing component 202, for example, can normalize the name for the medical procedure to a common name.

As discussed above, preprocessing component 202 can perform these operations on one or more views of new data source 412, and the one or more views can be employed by operations of ETL component 104 (e.g., and subcomponents thereof) described below. Alternatively, preprocessing component 202 can perform these operations directly in new data source 412, which can be employed by operations of ETL component 104 (e.g., and subcomponents thereof) described below.

As indicated at element 406, mapping component 204 can generate table level and column level mappings from source schema 412a to target schema 414a of data target 414 and to one or more historical schemas 416a of historical data and transformation script repository 416. It is to be appreciated that mapping component 204 can employ schema-based and/or data-driven method to generate the mappings. In a non-limiting example, schema based methods can comprise comparisons of table and/or column names, including metadata annotations, between source schema 412a and target schema 414a and/or historical schema 416a to identify corresponding tables and/or columns. In another non-limiting example, data driven methods can comprise comparisons of data values in columns of data records between source dataset 412b and target dataset 414b and/or historical datasets 416c to identify corresponding tables and/or columns.

For example, mapping component 204 can identify specific columns of source schema 412a that map to specific columns of target schema 414a. It is to be appreciated that, in some instances, not all columns of source schema 412a map to specific columns of target schema 414a. In another example, mapping component 204 can identify specific columns of source schema 412a that map to specific columns of the one or more historical schemas 416a. It is to be appreciated that, in some instances, not all columns of source schema 412a map to specific columns of a historical schema 416a.

Mapping component 204 can maintain any suitable data structure for the mappings. In a non-limiting example, a mapping data structure can comprise at the column level, mapping_c(c1, c2)=1 if column c1 of source schema 412a maps to column c2 of target schema 414a or historical schema 416a, otherwise mapping_c(c1, c2)=0. A mapping data structure can comprise at the table level, for table t1 of source schema 412a and table t2 of target schema 414a or historical schema 416a, mapping_t(t1, t2)=1 if max (mapping_c(t1.c1, t2.c2))>th, where th is a threshold, otherwise mapping_t(t1, t2)=0. It is to be appreciated that th can be any suitable threshold that is specified by an entity (e.g., machine, hardware, software, human), predetermined, or dynamically determined by mapping component 204.

As indicated at element 408, transformation script generation component 206 can employ the mappings to identify candidate transformation scripts from portions of historical transformation scripts 416b for employment in ETL processing of new data source 412 to data target 414. For example, transformation script generation component 206 can evaluate a historical transformation script 416b based on the mappings to determine nodes of a query plan tree of the historical transformation script 416b that are enabled. For example, if a node of the query plan tree corresponds to a column of the historical schema 416a that is mapped to a column of source schema 412a according to the mappings, then the node is enabled. Otherwise, if the node of the query plan tree corresponds to a column of the historical schema 416a that is not mapped to a column of source schema 412a according to the mappings, then the node is not enabled.

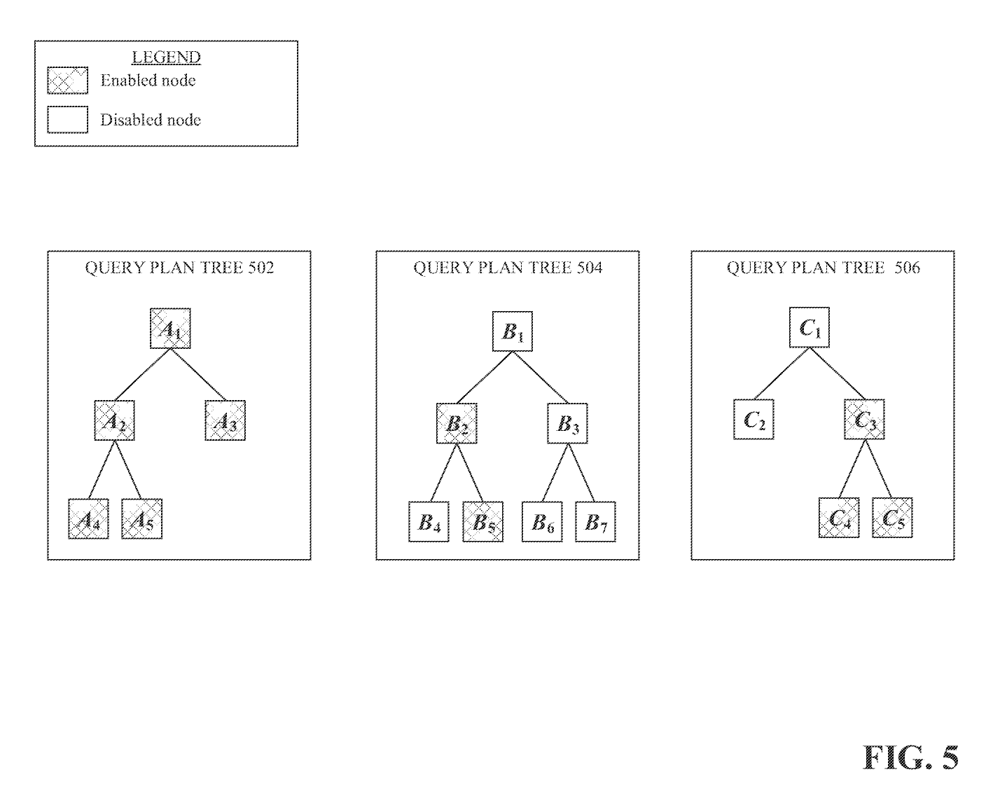

FIG. 5 illustrates a block diagram of example, non-limiting query plan trees in accordance with one or more embodiments described herein. Repetitive description of like elements employed in one or more embodiments described herein is omitted for sake of brevity. In this non-limiting example, query plan tree 502 has five data nodes A₁, A₂, A₃, A₄, and A₅, of which all are determined enabled by transformation script generation component 206 as indicated by the patterned fill. Query plan tree 504 has seven data nodes B₁, B₂, B₃, B₄, B₅, B₆, and B₇, of which nodes are B₂ and B₅ are determined enabled by transformation script generation component 206 as indicated by the patterned fill, and B₁, B₃, B₄, B₆, and B₇ are determined not enabled by transformation script generation component 206. Query plan tree 506 has five data nodes C₁, C₂, C₃, C₄, and C₅, of which nodes are C₃, C₄, and C₅ are determined enabled by transformation script generation component 206 as indicated by the patterned fill, and C₁ and C₂ are determined not enabled by transformation script generation component 206.

Transformation script generation component 206 can determine whether a query plan tree is valid based on the enable nodes. For example, if all the nodes in the query plan tree are enabled, such as in query plan tree 502, then the query plan tree is valid. In another example, if a subtree of the query plan tree has all its nodes enabled, then the subtree of the query plan tree is valid, such as nodes C₃, C₄, and C₅ forming a subtree of query plan tree 506, and node B₅ of query plan tree 504. In a further example, if a subtree of a query plan tree has at least one node that is not enabled, then the subtree is invalid, such as subtree comprising nodes B₂, B₄, and B₅ of query plan tree 504.

Transformation script generation component 206 can tag each valid query plan tree and subtree as a candidate transformation script. Transformation script generation component 206 can generate respective ranking scores for the candidate transformation scripts based on a ranking criterion. In a non-limiting example, a ranking criterion can be based on number of nodes enabled in the candidate transformation script. For example, if a first candidate transformation script has more enabled nodes than a second candidate transformation script, the first candidate transformation script can be given a higher ranking than the second transformation script. In another non-limiting example, a ranking criterion can be based on completeness of the candidate transformation script. Completeness can comprise an amount of a query plan tree that is included in a candidate transformation script. For example, if a greater portion of a query plan tree is used in a first candidate transformation script than a second candidate transformation script associated with another query plan tree, the first candidate transformation script can be given a higher ranking than the second transformation script. In another example, a ranking criterion can be based on whether one or more columns mapped in the candidate transformation script are also mapped in other candidate transformation scripts. For example, if a column of the new data source is only mapped to one or a small number of candidate transformation scripts, a higher ranking can be assigned to those candidate transformation scripts. This can advantageously help to ensure that more columns of the new data source are mapped to higher ranked candidate transformation scripts. It is to be appreciated that any suitable ranking criterion or combination of ranking criteria can be employed for determining a ranking score for a candidate transformation script.

Referring back to FIG. 4, as indicated at element 410, transformation script evaluation component 208 can evaluate performance of candidate transformation scripts. In a non-limiting example, transformation script evaluation component 208 can select a top-k ranked candidate transformation scripts for evaluation, where k is an integer indicating the number of candidate scripts that will be evaluated. It is to be appreciated that k can be specified by a entity (e.g., machine, hardware, software and/or human), predetermined, or dynamically determined by transformation script evaluation component 208.

Transformation script evaluation component 208 can determine respective performance scores for candidate transformation scripts based on a performance criterion, such as an accuracy criterion and/or resource utilization of a candidate transformation script. In a non-limiting example, transformation script evaluation component 208 can execute a candidate transformation script on a sample dataset (e.g. sample source dataset and sample target dataset) from historical datasets 416c and determine an accuracy of the results of the transformation of the sample source dataset as compared to the sample target dataset and based on an accuracy criterion. A non-limiting example of an accuracy criterion can include a similarity statistic, such as based on term frequency-inverse document frequency (tf-idf), word/numeric/datetime vector similarity measurements, column data types, Euclidean distance, or Mahalanobis distance, or any other suitable similarity measurement. Transformation script evaluation component 208 can assign a performance score to the candidate transformation script based on the determined accuracy. For example, if a first candidate transformation script has a higher accuracy than a second candidate transformation script, the first candidate transformation script can be given a higher performance score than the second transformation script.

It is to be appreciated that any suitable performance criterion or combination of performance criteria can be employed for determining a performance score for a candidate transformation script.

In another example, transformation script evaluation component 208 can determine a resource utilization (e.g., memory utilization, storage utilization, processing utilization, bandwidth utilization, or any other suitable resource utilization) of a candidate transformation script, and assign a performance score to the candidate transformation script based on the determined resource utilization. For example, if a first candidate transformation script has a lower resource utilization than a second candidate transformation script, the first candidate transformation script can be given a higher performance score than the second transformation script. An output of transformation script evaluation component 208 can include performance scored transformation scripts 418, which are the candidate transformation scripts with assigned performance scores.

Referring back to FIG. 2, in a non-limiting example, recommendation component 210 can select one or more performance scored transformation scripts 418 and present them in a display (e.g., graphical user interface or other display device) for an entity (e.g., machine, hardware, software and/or human) to select from to employ in migrating new data source 412 to data target 414. In another example, ETL component 104 can automatically employ one or more performance scored transformation scripts 418 in migrating new data source 412 to data target 414. In a non-limiting example, recommendation component 210 and/or ETL component 104 can select a set of j highest performance scored transformation scripts 418, where j is the number of performance scored transformation scripts 418 selected.

While FIGS. 1, 2, 3, 4, and 5 depict separate components in computing device 102, it is to be appreciated that two or more components can be implemented in a common component. Further, it is to be appreciated that the design of the computing device 102 can include other component selections, component placements, etc., to facilitate automatically performing ETL processing of one or more data sources to a data target in accordance with one or more embodiments described herein. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

Further, some of the processes performed can be performed by specialized computers for carrying out defined tasks related to automatically performing ETL processing of one or more data sources to a data target. The subject computer processing systems, methods apparatuses and/or computer program products can be employed to solve new problems that arise through advancements in technology, computer networks, the Internet and the like. The subject computer processing systems, methods apparatuses and/or computer program products can provide technical improvements to systems automatically performing ETL processing of one or more data sources to a data target in a live environment by improving processing efficiency among processing components in these systems, reducing delay in processing performed by the processing components, and/or improving the accuracy in which the processing systems automatically performing ETL processing of one or more data sources to a data target.

The embodiments of devices described herein can employ artificial intelligence (AI) to facilitate automating one or more features described herein. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determination.

A classifier can map an input attribute vector, z=(z1, z2, z3, z4, zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

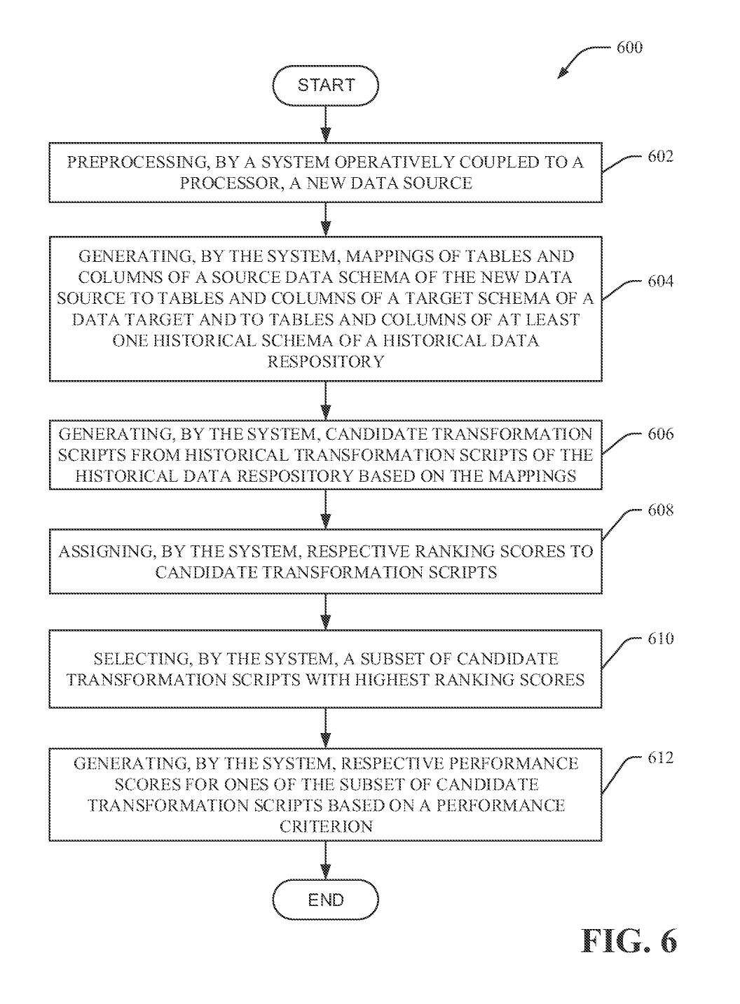

FIG. 6 illustrates a flow diagram of an example, non-limiting computer-implemented method 600 that facilitates automatically performing ETL processing of one or more data sources to a data target is provided in accordance with one or more embodiments described herein. Repetitive description of like elements employed in other embodiments described herein is omitted for sake of brevity.

At 602, method 600 can comprise preprocessing, by a system operatively coupled to a processor, a new data source (e.g., via a preprocessing component 202, an ETL component 104, and/or a computing device 102). At 604, method 600 can comprise generating, by the system, mappings of tables and columns of a source data schema of the new data source to tables and columns of a target schema of a data target and to tables and columns of at least one historical schema of a historical data repository (e.g., via a mapping component 204, an ETL component 104, and/or a computing device 102). At 606, method 600 can comprise generating, by the system, candidate transformation scripts from historical transformation scripts of the historical data repository based on the mappings (e.g., via a transformation script generation component 206, an ETL component 104, and/or a computing device 102). At 608, method 600 can comprise assigning, by the system, respective ranking scores to candidate transformation scripts (e.g., via a transformation script generation component 206, an ETL component 104, and/or a computing device 102). At 610, method 600 can comprise selecting, by the system, a subset of candidate transformation scripts with highest ranking scores (e.g., via a transformation script evaluation component 208, an ETL component 104, and/or a computing device 102). At 612, method 600 can comprise generating, by the system, respective performance scores for ones of the subset of candidate transformation scripts based on a performance criterion (e.g., via a a transformation script evaluation component 208, an ETL component 104, and/or a computing device 102).

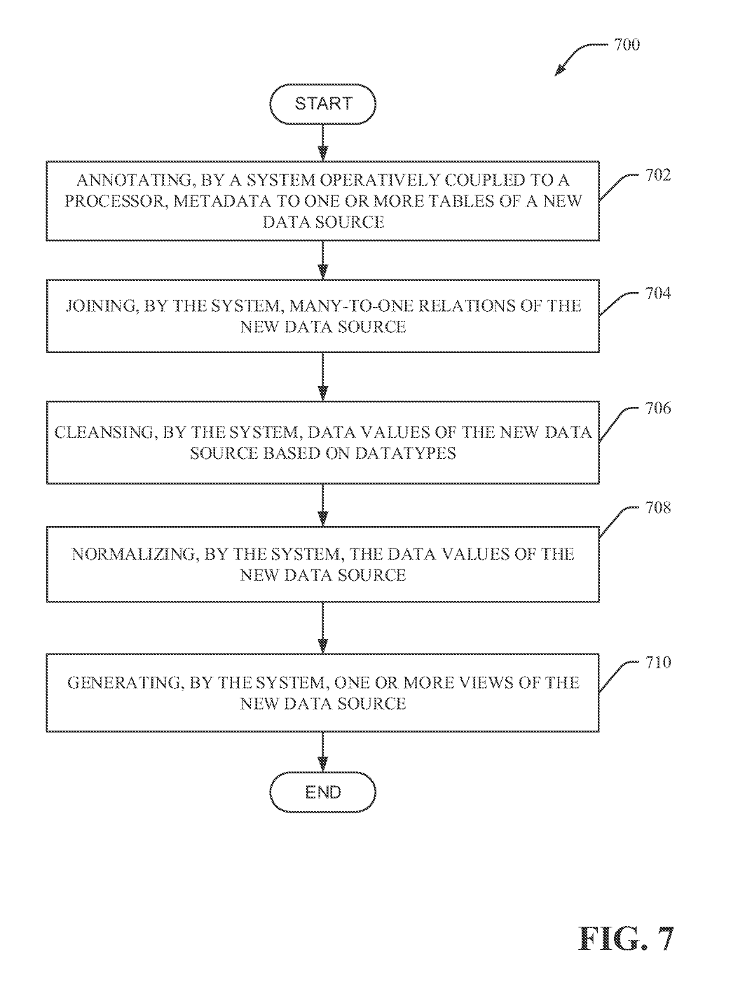

FIG. 7 illustrates a flow diagram of an example, non-limiting computer-implemented method 700 that facilitates automatically preprocessing a new data source in accordance with one or more embodiments described herein. Repetitive description of like elements employed in other embodiments described herein is omitted for sake of brevity.

At 702, method 700 can comprise annotating, by a system operatively coupled to a processor, metadata to one or more tables of a new data source (e.g., via a preprocessing component 202, an ETL component 104, and/or a computing device 102). At 704, method 700 can comprise joining, by the system, many-to-one relations of the new data source (e.g., via a preprocessing component 202, an ETL component 104, and/or a computing device 102). At 706, method 700 can comprise cleansing, by the system, data values of the new data source based on data types (e.g., via a preprocessing component 202, an ETL component 104, and/or a computing device 102). At 708, method 700 can comprise normalizing, by the system, the data values of the new data source (e.g., via a preprocessing component 202, an ETL component 104, and/or a computing device 102). At 710, method 700 can comprise generating, by the system, one or more views of the new data source (e.g., via a preprocessing component 202, an ETL component 104, and/or a computing device 102).

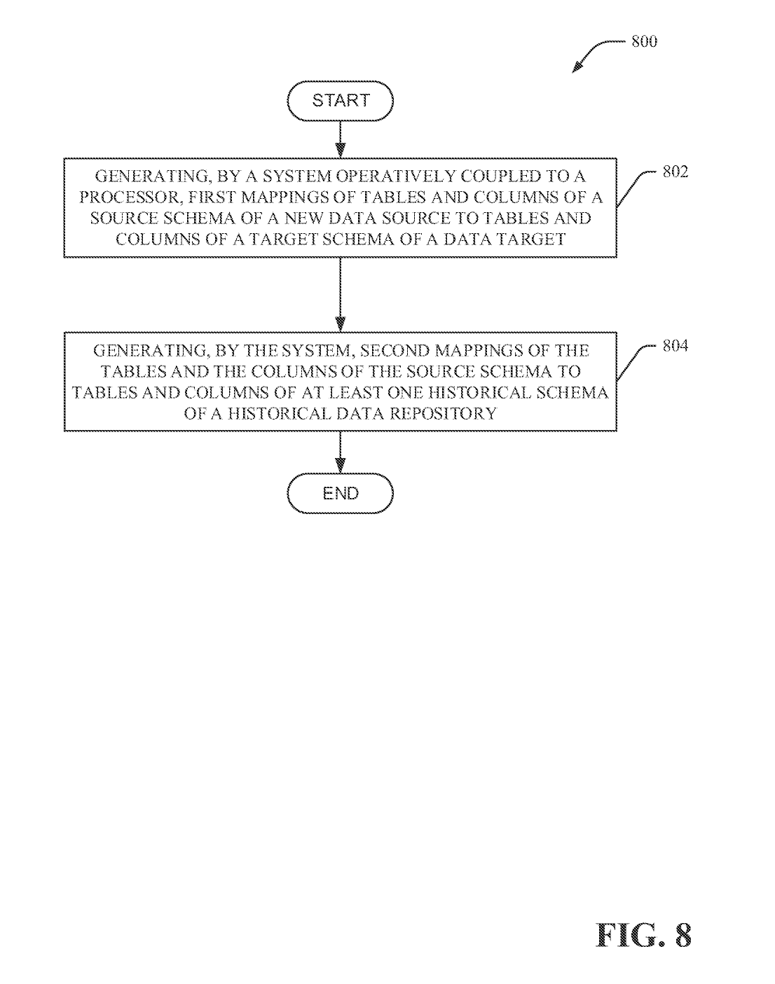

FIG. 8 illustrates a flow diagram of an example, non-limiting computer-implemented method 800 that facilitates automatically generating mappings of a new data source to a data target and historical data repository in accordance with one or more embodiments described herein. Repetitive description of like elements employed in other embodiments described herein is omitted for sake of brevity.

At 802, method 800 can comprise generating, by a system operatively coupled to a processor, first mappings of tables and columns of a source schema of a new data source to tables and columns of a target schema of a data target (e.g., via a mapping component 204, an ETL component 104, and/or a computing device 102). At 804, method 800 can comprise generating, by the system, second mappings of the tables and the columns of the source schema to tables and columns of at least one historical schema of a historical data repository (e.g., via a mapping component 204, an ETL component 104, and/or a computing device 102).

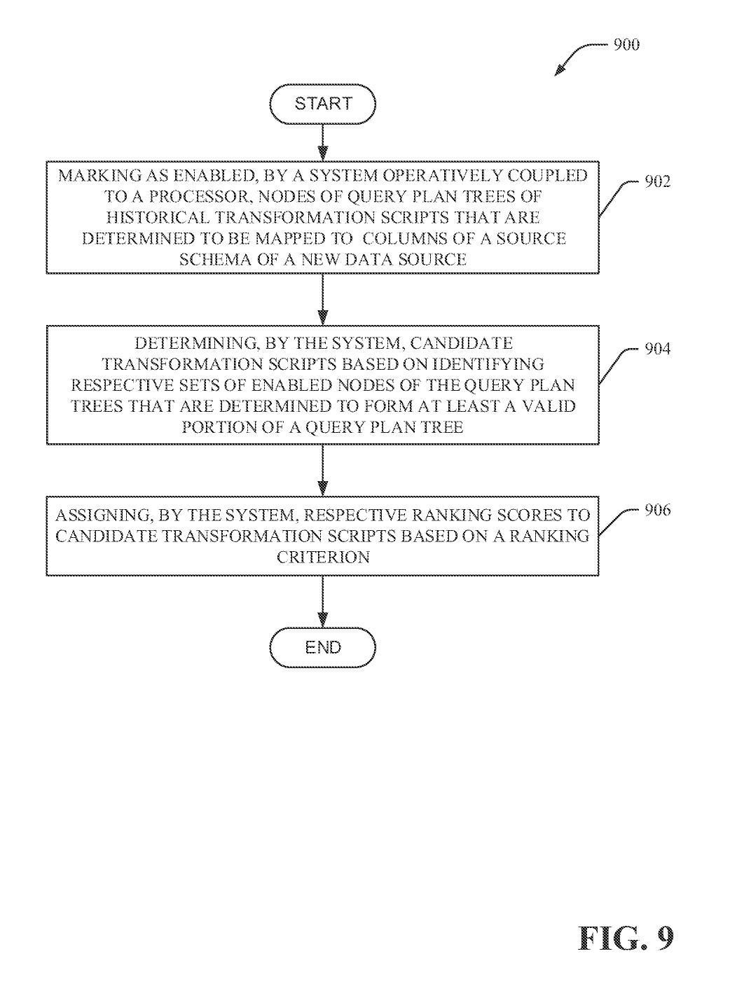

FIG. 9 illustrates a flow diagram of an example, non-limiting computer-implemented method 900 that facilitates automatically generating candidate transformation scripts in accordance with one or more embodiments described herein. Repetitive description of like elements employed in other embodiments described herein is omitted for sake of brevity.

At 902, method 900 can comprise marking as enabled, by a system operatively coupled to a processor, nodes of query plan trees of historical transformation scripts that are determined to be mapped to columns of a source schema of a new data source (e.g., via a transformation script generation component 206, an ETL component 104, and/or a computing device 102). At 904, method 900 can comprise determining, by the system, candidate transformation scripts based on identifying respective sets of enabled nodes of the query plan trees that are determined to form at least a valid portion of a query plan tree (e.g., via a transformation script generation component 206, an ETL component 104, and/or a computing device 102). At 906, method 900 can comprise assigning, by the system, respective ranking scores to candidate transformation scripts based on a ranking criterion (e.g., via a transformation script generation component 206, an ETL component 104, and/or a computing device 102).

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

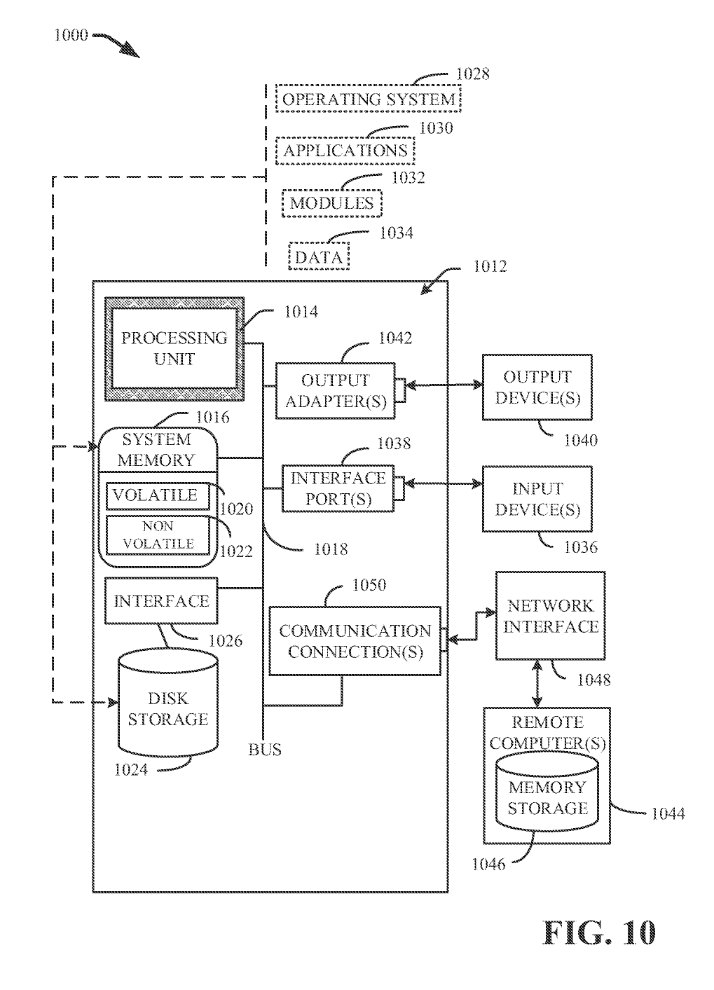

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1494), and Small Computer Systems Interface (SCSI). The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012. System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

In an embodiment, for example, computer 1012 can perform operations comprising: in response to receiving a query, selecting, by a system, a coarse cluster of corpus terms having a defined relatedness to the query associated with a plurality of coarse clusters of corpus terms; determining, by the system, a plurality of candidate terms from search results associated with the query; determining, by the system, at least one recommended query term based on refined clusters of the coarse cluster, the plurality of candidate terms, and the query; and communicating at least one recommended query term to a device associated with the query.

It is to further be appreciated that operations of embodiments disclosed herein can be distributed across multiple (local and/or remote) systems.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products, and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor, operably coupled to the memory, and that executes computer executable components stored in the memory, wherein the computer executable components comprise:
a transformation script evaluation component that determines respective performance scores for a first set of candidate transformation scripts based on a performance criterion, wherein the candidate transformation scripts are related to extract, transform, load (ETL) processing of a new data source to a data target; and
a recommendation component that generates a recommendation of one or more of the first set of candidate transformation scripts based on the respective performance scores for performance of the ETL processing.

2. The system of claim 1, further comprising a mapping component that generates mappings of tables and columns of a source data schema of the new data source to tables and columns of a target schema of the data target and to tables and columns of at least one historical schema of a historical data repository.

3. The system of claim 2, further comprising a transformation script generation component that generates a set of candidate transformation scripts from historical transformation scripts of the historical data repository based on the mappings, wherein the set of candidate transformation scripts comprises the first set of candidate transformation scripts.

4. The system of claim 3, wherein the transformation script generation component assigns respective ranking scores to candidate transformation scripts of the set of candidate transformation scripts.

5. The system of claim 4, wherein the transformation script evaluation component selects a defined quantity of highest ranking candidate transformation scripts of the set of candidate transformation scripts based on the respective ranking scores as the first set of candidate transformation scripts.

6. The system of claim 1, wherein the performance criterion is based on utilization of at least one resource selected from the group consisting of a processor, a memory, a storage device, and a network bandwidth.

7. The system of claim 1, further comprising a preprocessing component that preprocesses the new data source, wherein preprocessing comprises at least one process selected from the group consisting of annotation of metadata to a source schema of the new data source, cleaning of data values of the new data source based on one or more data types, normalization of the data values of the new data source, and generation of one or more views of the new data source.

8. A computer-implemented method, comprising:
determining, by a system operatively coupled to a processor, respective performance scores for a first set of candidate transformation scripts based on a performance criterion, wherein the candidate transformation scripts are related to extract, transform, load (ETL) processing of a new data source to a data target; and
generating, by the system, a recommendation of one or more of the first set of candidate transformation scripts based on the respective performance scores for performance of the ETL processing.

9. The computer-implemented method of claim 8, further comprising:
generating, by the system, mappings of tables and columns of a source data schema of the new data source to tables and columns of a target schema of the data target and to tables and columns of at least one historical schema of a historical data repository.

10. The computer-implemented method of claim 9, further comprising generating, by the system, a set of candidate transformation scripts from historical transformation scripts of the historical data repository based on the mappings, wherein the set of candidate transformation scripts comprises the first set of candidate transformation scripts.

11. The computer-implemented method of claim 10, further comprising assigning, by the system, respective ranking scores to candidate transformation scripts of the set of candidate transformation scripts.

12. The computer-implemented method of claim 11, further comprising selecting, by the system, a defined quantity of highest ranking candidate transformation scripts of the set of candidate transformation scripts based on the respective ranking scores as the first set of candidate transformation scripts.

13. The computer-implemented method of claim 8, wherein the performance criterion is based on a determined accuracy of executing of a candidate transformation script on a sample historical dataset.

14. The computer-implemented method of claim 8, further comprising preprocessing, by the system, the new data source, wherein the preprocessing comprises at least one process selected from the group consisting of annotating metadata to a source schema of the new data source, cleaning data values of the new data source based on one or more data types, normalizing the data values of the new data source, and generating one or more views of the new data source.

15. A computer program product facilitating extract, transform, load (ETL) processing of a new data source to a data target, the computer program product comprising a computer readable storage medium having program instructions embodied therewith, the program instructions executable by a processor to cause the processor to:
determine respective performance scores for a first set of candidate transformation scripts based on a performance criterion, wherein the candidate transformation scripts are related to extract, transform, load (ETL) processing of a new data source to a data target; and
generate a recommendation of one or more of the first set of candidate transformation scripts based on the respective performance scores for performance of the ETL processing.

16. The computer program product of claim 15, wherein the program instructions are executable by the processor to further cause the processor to:
generate mappings of tables and columns of a source data schema of the new data source to tables and columns of a target schema of the data target and to tables and columns of at least one historical schema of a historical data repository.

17. The computer program product of claim 16, wherein the program instructions are executable by the processor to further cause the processor to:
generate a set of candidate transformation scripts from historical transformation scripts of the historical data repository based on the mappings, wherein the set of candidate transformation scripts comprises the first set of candidate transformation scripts.

18. The computer program product of claim 17, wherein the program instructions are executable by the processor to further cause the processor to:
assign respective ranking scores to candidate transformation scripts of the set of candidate transformation scripts.

19. The computer program product of claim 18, wherein the program instructions are executable by the processor to further cause the processor to:
select a defined quantity of highest ranking candidate transformation scripts of the set of candidate transformation scripts based on the respective ranking scores as the first set of candidate transformation scripts.

20. The computer program product of claim 15, wherein the performance criterion is based on utilization of at least one resource selected from the group consisting of a processor, a memory, a storage device, and a network bandwidth.
